(19) United States
(12) Patent Application Publication
(10) Pub. No.: US 2002/0048295 A1
(43) Pub. Date: Apr. 25, 2002

(54) Laser diode module and mounting board

(75) Inventors: Tomoya Kato, Tokyo (JP); Takeo Shimizu, Tokyo (JP); Masayuki Iwase, Tokyo (JP); Hideaki Murata, Tokyo (JP)

Correspondence Address: OBLON SPIVAK MCCLELLAND MAIER & NEUSTADT PC, FOURTH FLOOR, 1755 JEFFERSON DAVIS HIGHWAY, ARLINGTON, VA, 22202, US

(73) Assignee: The Furukawa Electric Co., LTD., Tokyo (JP)

(21) Appl. No.: 09/977,983

(22) Filed: Oct. 17, 2001

(30) Foreign Application Priority Data
Oct. 20, 2000 (JP) 2000-321377

(51) Int. Cl. H01S 3/04

(52) U.S. Cl. 372/36

(57) ABSTRACT

A laser diode module of the invention can release heat radiated from a laser diode efficiently, and is of small size and small power consumption. An outer surface (15) of a bottom plate (2) of a package (7) is formed to be a board mounting surface to be mounted on a printed board (20). A base (6) is fixed to the inner wall surface (9) side of the top plate (8) of the package (7) and a laser diode (3) is fixed to the base (6). In the invention, an exemplary configuration where heat radiated from the laser diode is released effectively is formed by disposing a heat radiating unit (4) on the outer surface (16) side of the top plate (8) of the package (7), for example. The heat radiating unit (4) is formed by disposing a plurality of heat radiating fins (5) arranged at intervals, for example. The configuration containing the heat radiating unit (4) releases heat radiated from the laser diode (3) through the base (6), the top plate (8) and the heat radiating unit (4).

### FIELD OF THE INVENTION

The present invention relates to a laser diode module and a mounting board for use in optical communications.

### BACKGROUND OF THE INVENTION

Recently, large amounts of laser diodes (semiconductor lasers) have been used in optical communications as signal light sources or optical amplifier pumping sources, for example. A laser diode module is a module that optically couples laser light emitted from the laser diode to an optical fiber, which has been developed variously.

As an example of the aforesaid laser diodes, there is a DFB (distributed feedback) laser diode having a few mW of output, for example. FIGS. 6 and 7 depict one example of the laser diode module with the DFB laser diode. Additionally, FIG. 6 depicts a laser diode module 1 being mounted on a printed board 20 as a substrate. FIG. 7 depicts a perspective view of an appearance of this laser diode module 1.

As shown in these drawings, the laser diode module 1 has a package 7 made of metal or ceramics. An outer surface 15 of a bottom plate 2 of the package 7 is formed to be a board mounting surface for contacting with the resin printed board 20 for mounting. The package 7 is mounted by screw cramping in some cases. Lead terminals 19 are extended downward from side walls 24 of the package 7. These lead terminals 19 are inserted into terminal through holes (not shown) formed in the printed board 20 and are fixed to the printed board 20 by solder joining or screws. In addition, the electric wirings of the laser diode module 1 are electrically connected to the electrical wirings of the printed board 20 through the lead terminals 19.

A metal base 6 is fixed on the bottom plate 2 of the laser diode module 1. On the base 6, a monitor photodiode 13, a laser diode 3, a first lens 10 and an isolator 11 are arranged and fixed with a space separating each other. The first lens 10 is a collimate lens that makes light emitted from the laser diode 3 to be parallel light. The isolator 11 is a polarization dependent optical isolator.

A front end side wall 27 of the package 7 is formed with a through hole 25. The through hole 25 is inserted and fixed with a lens holder 26. On the back end side of the lens holder 26, a light transparent plate 40 is fixed. The light transparent plate 40 is formed of sapphire glass and the package is sealed. A second lens 12 is fixed midway in the lens holder 26. Furthermore, on the front end side of the lens holder 26, a ferrule 45 is fixed. Into the ferrule 45 is inserted an optical fiber (a single mode optical fiber, for example) 14 and this is fixed thereto. On the end side of the ferrule 45, a rubber boot 41 for protecting the optical fiber 14 is disposed.

In the aforementioned laser diode module 1, the laser light emitted from the laser diode 3 is made to be parallel light by the first lens 10. The laser lights then enter and passes through the optical isolator 11. After that, the laser light is focussed at the incident end face (connection end face) of the optical fiber 14 by the second lens 12. And then, the lights enter the optical fiber 14 and are guided inside the optical fiber 14 for a desired purpose.

### SUMMARY OF THE INVENTION

The invention is to provide a laser diode module and a mounting board for mounting the laser diode module.

The laser diode module of the invention comprises:

a package; and

a laser diode housed inside the package,

wherein the outer surface of a bottom plate of the package is formed to be a board mounting surface for board mounting, and

the laser diode is fixed to a laser diode mounting part disposed on the inner wall surface side of a top plate of the package.

### BRIEF DESCRIPTION OF THE DRAWINGS

Exemplary embodiments of the invention will now be described in conjunction with drawings, in which:

FIG. 1A depicts a sectional view of a principal part illustrating one embodiment of the laser diode module in the invention in a board mounted state;

FIG. 1B depicts a side view of a principal part illustrating the embodiment of the laser diode module in the invention in a board mounted state;

FIG. 2 depicts schematic diagrams of a method for fabricating the embodiment of the laser diode module in the invention;

FIG. 3 depicts a sectional illustration showing another embodiment of the laser diode module in the invention in a board mounted state;

FIG. 4 depicts a sectional illustration showing still another embodiment of the laser diode module in the invention in a board mounted state;

FIG. 5 depicts a sectional illustration showing yet another embodiment of the laser diode module in the invention in a board mounted state;

FIG. 6 depicts a sectional illustration showing one example of an conventional laser diode module in a board mounted state; and

FIG. 7 depicts a perspective illustration of the laser diode module shown in FIG. 6.

### DETAILED DESCRIPTION

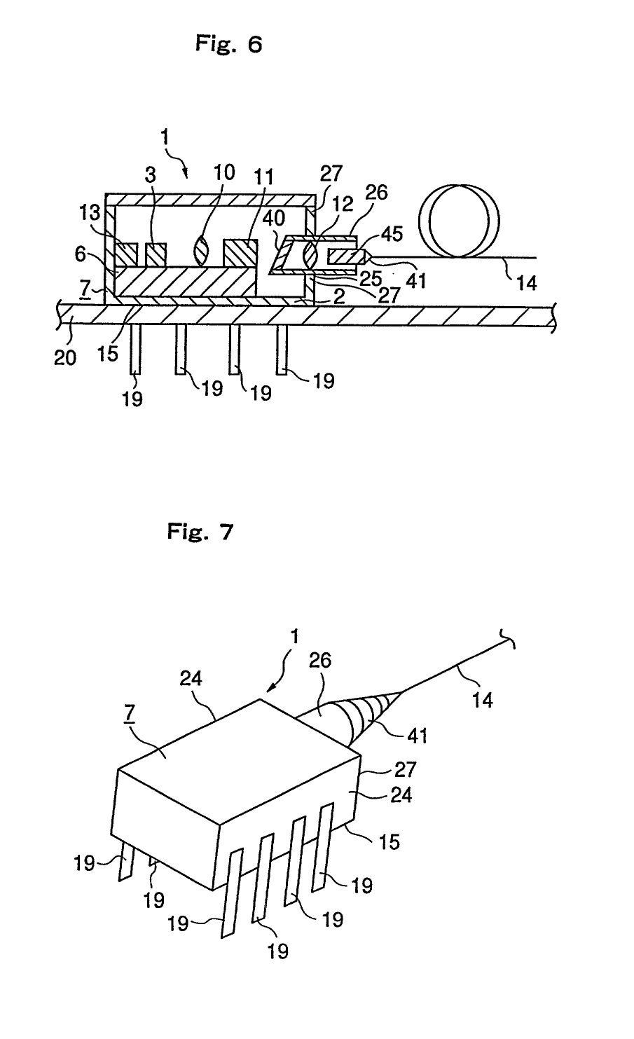

The conventional laser diode module shown in FIG. 6 is formed in which the base 6 mounting the laser diode 3 is fixed on the bottom plate 2 of the package 7. Additionally, the bottom plate 2 is disposed to contact with the resin printed board 20 having a poor thermal conductivity. According to this configuration, the conventional laser diode module releases heat radiated from the laser diode 3 through the printed board 20. On this account, the conventional laser diode module has had poor efficiency of heat radiation from the laser diode 3.

Accordingly, in the conventional laser diode module, the output of the laser diode 3 has not been obtained adequately because heat is not released sufficiently from the laser diode 3. Furthermore, various problems have arisen in the conventional laser diode module such that the lifetime of the laser diode 3 is shortened and the oscillation wavelength in the laser diode 3 is not stable because heat is not released sufficiently from the laser diode 3.

Moreover, the conventional laser diode module has a configuration where heat radiated from the laser diode 3 is released as described above. This configuration is that a heat radiating unit such as a Peltier module (Peltier cooler) is disposed inside the package 7. However, when the Peltier module is disposed inside the package 7, the wiring form thereof causes the laser diode module to be upsized about four times, for example. In addition, when the Peltier module is disposed, power consumption is increased by that amount for cost rise.

Particularly, the development of optical communication systems such as wavelength division multiplexing (WDM) transmission has been practiced actively in these years, and the laser diode 3 has been used as a pumping source for an optical fiber amplifier. This kind of laser diode 3 has an output of a few hundreds mW, for example, which means there is a large amount of heat released and thus the aforementioned problems have been serious.

The laser diode module and the mounting board in one aspect of the invention can release heat radiated from the laser diode efficiently, which can suppress power consumption and achieve a decrease in size.

Hereafter, the embodiments of the invention will be described with reference to the drawings. Additionally, in the description of the following embodiments, portions having the same names as the conventional example are designated the same numerals and signs, omitting the overlapping explanation.

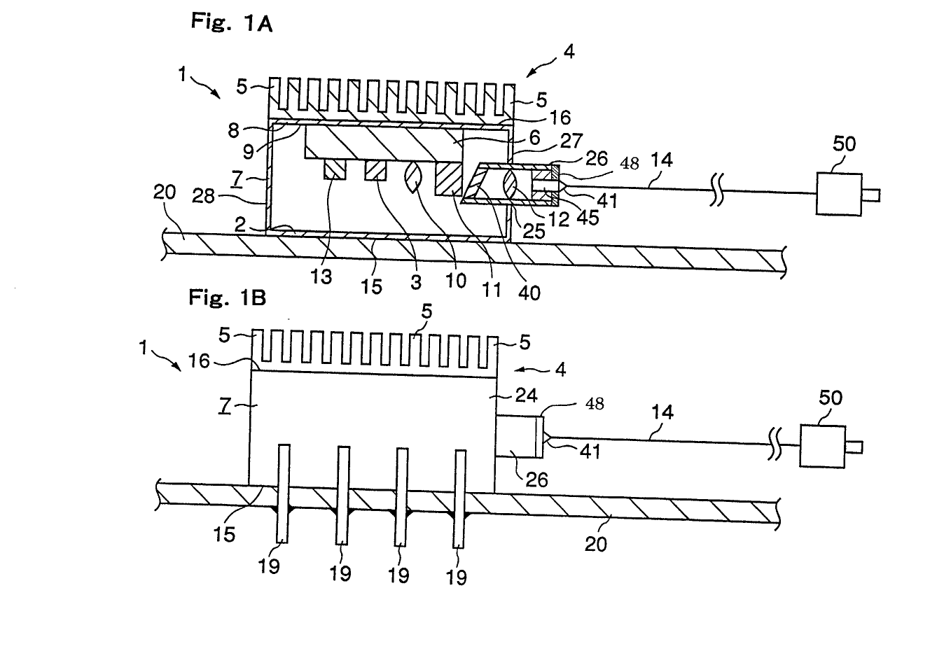

FIG. 1A depicts a sectional view of one embodiment of the laser diode module in the invention. FIG. 1B depicts a side view of this laser diode module. FIGS. 1A and 1B depict the laser diode module being mounted on a printed board as a substrate. Additionally, in FIG. 1A, lead terminals 19 shown in FIG. 1B are omitted. In FIG. 1B, the printed board 20 is shown by a sectional view when it is cut at insertion parts of the lead terminals 19.

Firstly, the laser diode module 1 of the embodiment is characterized in that a base 6 as a laser diode mounting part is fixed to the inner wall surface 9 side of a top plate 8 of a package 7 and a laser diode 3 is fixed to the base 6 directly or indirectly.

Secondly, the laser diode module 1 of the embodiment is characterized in that a heat radiating unit 4 is disposed on the outer surface 16 side of the top plate 8 of the package 7.

The heat radiating unit 4 is formed to have a plurality of heat radiating fins 5 disposed at intervals. The heat radiating unit 4 is formed of aluminum, which is attached and fixed to an outer surface 16 of the top plate 18 of the package 7 with a thermoconductive adhesive or double-faced tape, or a solder or brazing material. The example of the double-faced tape applied is Heat Joining Double-Faced Tape A90/20-2 (a product name) made of Furukawa Electric Co., Ltd.

Additionally, also in the laser diode module 1 of the embodiment, an outer surface 15 of a bottom plate 2 of the package 7 is formed to be a board mounting surf ace to be mounted on the printed board 20. In FIGS. 1A and 1B, 50 denotes an optical connector.

Furthermore, the laser diode module 1 of the embodiment is configured the same as the conventional laser diode module shown in FIG. 6 except for the configuration described above and therefore the description thereof will be omitted.

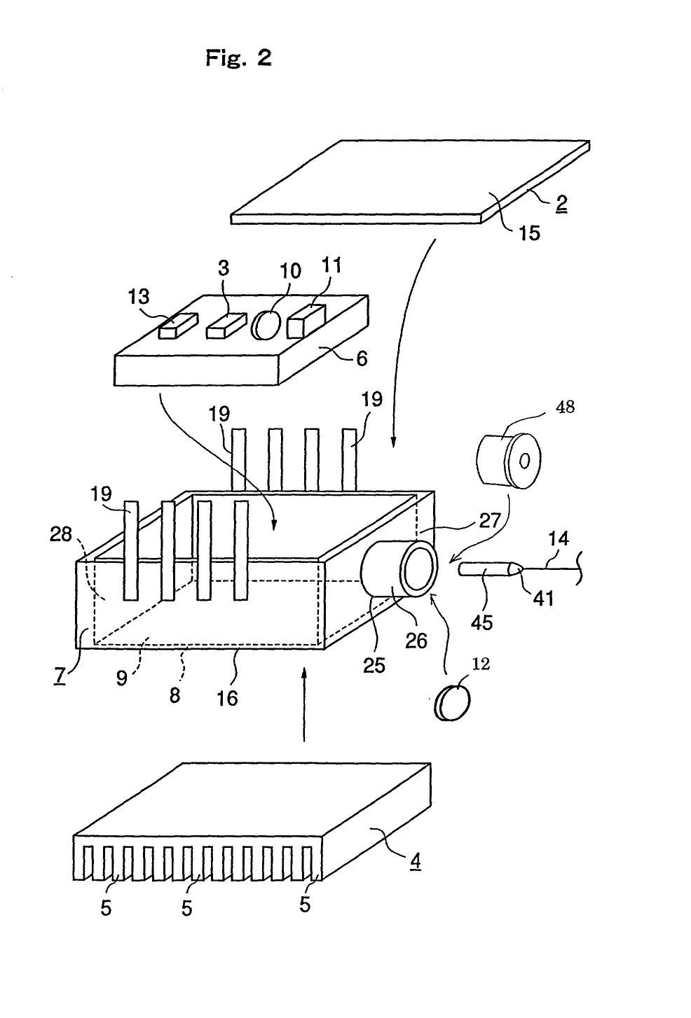

The laser diode module 1 of the embodiment is configured as described above, for example as shown in FIG. 2. That is, when fabricating the laser diode module 1, the package 7 having the bottom plate 2 separated is first prepared and is disposed with the top plate 8 of the package 7 downward, while a monitor photodiode 13, a laser diode 3, a first lens 10 and an isolator 11 are mounted on the base 6 with the centers aligned. The base 6 in this state is placed and fixed on the inner wall surface 9 of the top plate 8 of the package 7. Here, a second lens 12 is fixed inside a lens holder 26. Additionally, a ferrule 45 into which is inserted and fixed an optical fiber 14 is inserted into the lens holder 26 fixed to the package 7, through a ferrule sleeve 48.

Then, the optical axis of the laser diode 3 is matched with that of the optical fiber 14 and the base 6 is fixed to the inner wall surface 9 of the top plate 8 of the package 7. Furthermore, the ferrule 45 is fixed to the lens holder 26. Subsequently, the bottom plate 2 of the package 7 is fixed to side walls 24 and walls 27 and 28 of the package 7. Moreover, a heat radiating unit 4 is attached and fixed to the outer surface 16 side of the top plate 8 of the package 7 and thereby the laser diode module 1 is completed.

In addition, when the laser diode module 1 is mounted on the printed board 20, the bottom plate 2 of the package 7 is put downward and the outer surface 15 of the bottom plate 2 is formed to be a board mounting surface to the printed board 20, as described above. The printed board 20 mounting the laser diode module 1 is disposed inside an optical amplifier, for example. Furthermore, the inside of the optical amplifier may be cooled by a fan, as necessary.

In the embodiment, the laser diode 3 is fixed to the base 6 disposed on the inner wall surface 9 side of the top plate 8 of the package 7. On this account, heat radiated from the laser diode 3 passes through the base 6 and the top plate 8 of the package 7 and is released efficiently by the heat radiating unit 4.

In this manner, the laser diode module 1 of the embodiment allows heat radiated from the laser diode 3 to pass through the top plate 8 of the package 7 and to be released by the heat radiating unit 4. Therefore, the laser diode module of the embodiment can release heat radiated from the laser diode 3 more efficiently than the conventional example. The conventional example has poor heat radiation because it has a configuration in which heat radiated from the laser diode 3 is made to pass through the base 6 and the bottom plate 8 of the package 7 and then is released through the resin printed board 20 having a poor heat conductivity, as described above. Furthermore, in the laser diode module 1 of the embodiment, the heat radiating unit 4 is configured of a plurality of heat radiating fins 5. In this case, the heat radiating unit 4 is a small unit that does not need electric power.

As described above, the laser diode module 1 of the embodiment can sufficiently release heat radiated from the laser diode 3 sufficiently even though it has a high output laser diode 3. Moreover, the laser diode module 1 of the embodiment is a small-sized, low-cost laser diode module of small power consumption.

Additionally, the invention is not limited to the embodiment, which can adopt various embodiments. For example, in the embodiment, the heat radiating unit 4 was attached and fixed to the outer surface 16 of the top plate 8 of the package 7 with an adhesive or double-faced tape. However, the heat radiating unit 4 may be fixed by soldering or brazing, for example, or may be formed in one piece with the package 7 by molding. However, applying a method in which the heat radiating unit 4 is formed separately from the package 7 for fixing can enhance the assembly workability of the laser diode module 1 better than forming the heat radiating unit 4 in one piece with the package 7.

Furthermore, in the embodiment, the heat radiating unit 4 was configured to have a plurality of heat radiating fins 5. However, the heat radiating unit 4 is not defined specifically, but can be modified as desired. For example, the heat radiating unit 4 may be formed of a unit such as a heat radiating component circuit using a plate-shaped heat pipe made of copper. Such a heat radiating component circuit is configured to lead heat radiated from the laser diode 3, for example, to an appropriate place in the optical amplifier where the laser diode module 1 is disposed. The configuration of such the heat radiating component circuit is small-sized and can release heat radiated from the laser diode 3 effectively.

Moreover, the laser diode module 1 may be configured to omit the heat radiating unit 4. Also in this case, heat radiated from the heat radiating unit 4 is released outside the package 7 through the top plate 8 of the package 7. Therefore, the laser diode module 1 omitting the heat radiating unit 4 can also release heat radiated from the laser diode 3 effectively as compared with the conventional example which releases heat radiated from the laser diode 3 through the bottom plate 2 of the package 7 and the printed board 20.

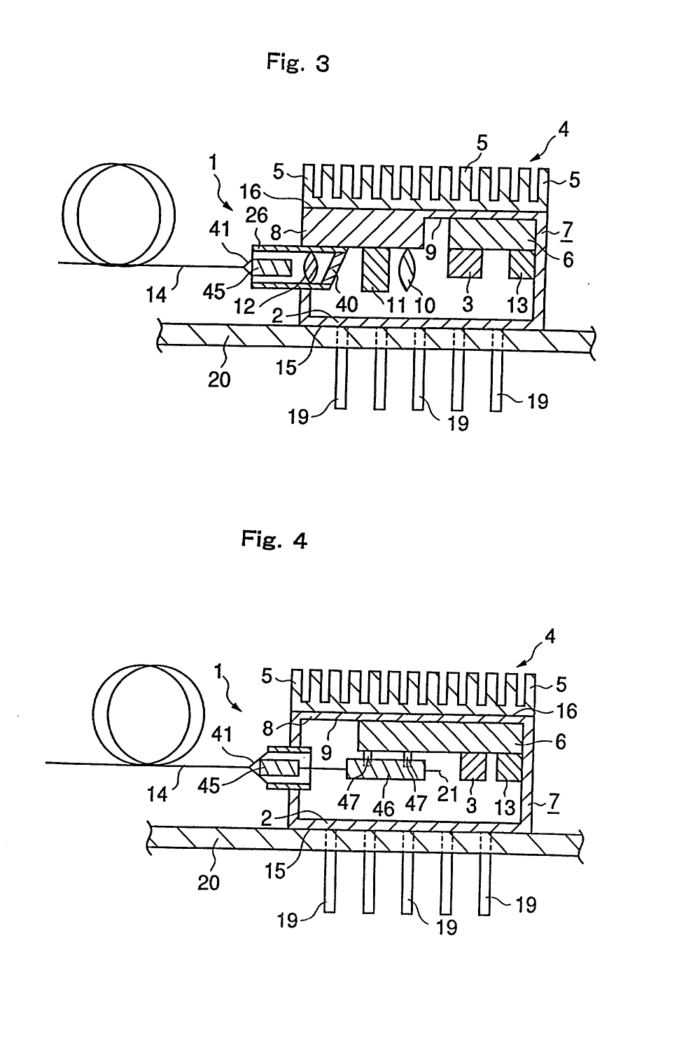

Besides, in the embodiment, the monitor photodiode 13, the laser diode 3, the first lens 10 and the isolator 11 were mounted on the base 6, but the configuration to mount these can be set arbitrarily. For example, FIG. 3 depicts another mounting configuration applied to the laser diode module 1. In this example, a projecting stepped portion of top plate 8 of a base 6 is formed, and a first lens 10 and an isolator 11 are directly disposed on this top plate 8. In addition, only the laser diode 3 and a monitor photodiode 13 are mounted on a base 2.

Furthermore, in the embodiment, the laser diode module 1 was configured to dispose two lenses 10 and 12. However, as shown in FIG. 4, the lenses 10 and 12 may be omitted. The configuration shown in FIG. 4 is in which a lens 21 is formed on the tip end side of an optical fiber 14 to make the optical fiber a lensed fiber and laser light emitted from a laser diode 3 directly enter the optical fiber 14. Moreover, 46 denotes a ferrule and 47 denotes a fixing part thereof in FIG. 4.

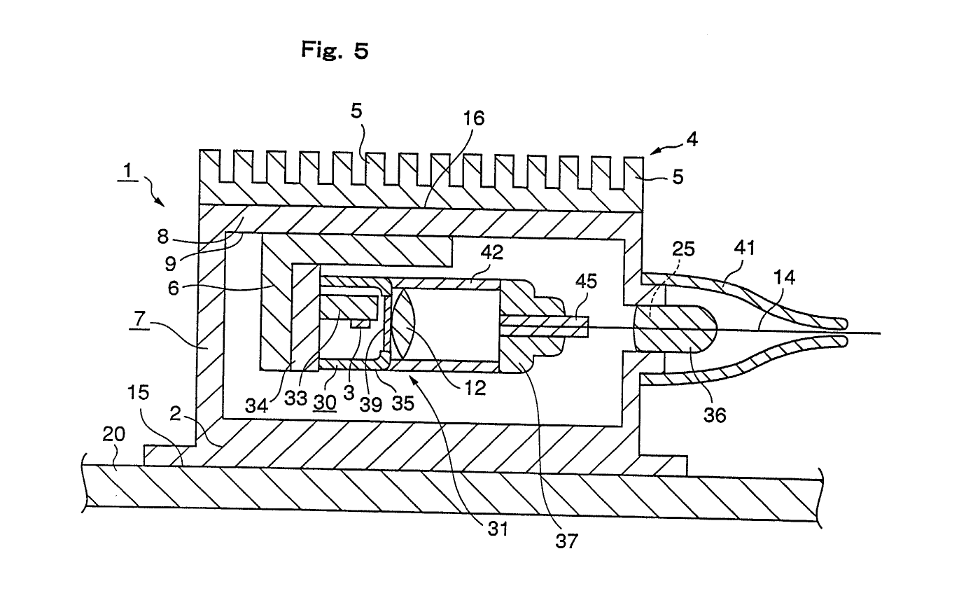

Besides, the laser diode module of the invention may be configured to have an internal module 31 as shown in FIG. 5. The internal module 31 is a coaxial internal module where a laser diode 3, a lens 12 and an optical fiber 14 are optically coupled beforehand.

The configuration of the internal module 31 will be described briefly. The internal module 31 has a can 30. The can 30 comprises a cylindrical, stainless steel cap 35 fixed to a rim part of a column-shaped stem 34. Additionally, the internal module 31 has a lens holder 42 with the lens 12 and a slide ring 37. The slide ring 37 is fixed with a ferrule 45 to which the optical fiber 14 is inserted and fixed.

The laser diode 3 is disposed inside the can 30 and the laser diode 3 is mounted and fixed to the stem 34 through a fixing block 33. The inside of the can 30 is hermetically sealed. Additionally, the cap 35 is disposed with a light transparent window 39 for transmitting lights oscillated from the laser diode 3. The laser lights that have passed through the light transparent window 39 pass through the lens 12 to be optically coupled to the optical fiber 14.

In the laser diode module 1 shown in FIG. 5, the internal module 31 having the aforementioned configuration is fixed to a base 6 which has an L-shaped section and the internal module 31 is fixed to the inner wall surface 9 side of a top plate 8 of a package 7 through the base 6. The configuration where the laser diode 3 and the optical fiber 14 are fixed to one component (the internal module) in an optical coupled state as in this laser diode module 1 can effectively suppress change in coupling efficiency with environmental temperature change.

Furthermore, 36 denotes a resin for package sealing in FIG. 5. Moreover, lead terminals are omitted in FIG. 5.

As described above, in the laser diode module of the invention, components disposed inside the package 7 other than the laser diode 3 and the configuration thereof are not defined specifically, and can be modified as desired. The invention may be such that the outer surface 15 of the bottom plate 2 of the package 7 is formed to be a board mounting surface for board mounting and the laser diode 3 is fixed to the laser diode mounting part disposed on the inner wall surface 9 side of the top plate 8 of the package 7.

Additionally, the laser diode module of the invention is not limited as to its purposes, which may be a signal light source or a pumping light module, for example.

Furthermore, in the embodiment, the lead terminals 19 were extended downward from the side walls 24 of the package 7. However, the lead terminals 19 may be extended from the side walls 24 of the package 7 toward the outside. That is, the configurational form of the lead terminals 19 disposed in the laser diode module 1 is set as appropriate.

What is claimed is:

1. A laser diode module comprising:
a package; and
a laser diode housed inside the package,
wherein an outer surface of a bottom plate of said package is formed to be a board mounting surface for board mounting, and
said laser diode is fixed to a laser diode mounting part disposed on an inner wall surface side of a top plate of said package.

2. The laser diode module according to claim 1, wherein a heat radiating unit is disposed on an outer surface side of a top plate of the package.

3. The laser diode module according to claim 2, wherein said heat radiating unit is formed to have a plurality of heat radiating fins.

4. The laser diode module according to claim 2, wherein said heat radiating unit is formed to have a plate-shaped heat pipe.

5. The laser diode module according to claim 2, wherein said heat radiating unit is fixed to said outer surface side of said top plate with a thermo conductive tape or a solder or a brazing material.

6. The laser diode module according to claim 1, wherein said laser diode is fixed to said laser diode mounting part without Peltier Cooler.

7. A mounting board upon which is mounted the laser diode module according to claim 1.
